(19) United States
(12) Patent Application Publication
(10) Pub. No.: US 2015/0321454 A1
(43) Pub. Date: Nov. 12, 2015

(54) RESIN FILM AND SLICED VENEER SHEET USING SAME AND AUTOMOBILE INTERIOR MEMBER

(71) Applicants: Nissen Chemitec Corporation, Niihama-shi, Ehime (JP); Kochi Prefectural, Kochi-shi, Kochi (JP)

(72) Inventors: Katsushi JINNO, Niihama-shi, Ehime (JP); Takashi FUJITA, Niihama-shi, Ehime (JP); Yutaro KAN, Niihama-shi, Ehime (JP); Nozomu BITO, Niihama-shi, Ehime (JP); Hayato SHINOHARA, Kochi-shi, Kochi (JP); Minoru YAMASHITA, Kochi-shi, Kochi (JP); Nozomu TSURUTA, Kochi-shi, Kochi (JP)

(21) Appl. No.: 14/408,846

(22) PCT Filed: Jun. 19, 2013
(86) PCT No.: PCT/JP2013/003829

§ 371 Date: Dec. 17, 2014

(30) Foreign Application Priority Data
Jun. 20, 2012 (JP) 2012-139008

(51) Int. Cl. B32B 21/08; B32B 27/08; B32B 5/02; B32B 27/36; B32B 27/40; C08J 5/18; B32B 27/32

(52) U.S. Cl. CPC B32B 21/08; C08J 5/18; B32B 27/08; B32B 27/32; B32B 27/36; B32B 27/365; B32B 27/40; B32B 5/022; C08J 2323/12; C08J 2423/26; B32B 2605/003; B32B 2307/402

(57) ABSTRACT

Provided is a resin film that can be firmly adhered to a native wood sliced veneer, has extremely low moisture permeability and oxygen permeability, and can provide the sliced veneer with excellent automobile interior suitability. A resin film 10 of the present invention includes: a melt-adhesion filling layer 12 formed of an olefin based resin whose melt flow rate (MFR: test condition being 170° C. and 2.1 kgf) is 2.5 to 33.0 g/10 min, the olefin based resin including a modified polyolefin resin; and a functional layer 14 that is formed of a thermoplastic resin and that is to be laminated on a surface of the melt-adhesion filling layer 12.

### TECHNICAL FIELD

The present invention relates to a resin film that is to be laminated on a native wood sliced veneer, and, in particular, the present invention relates to a resin film suitable for manufacturing a sliced veneer sheet for interior decoration of automobiles, a sliced veneer sheet using the resin film, and an automobile interior member.

### BACKGROUND ART

In recent years, the excellent design property of native wood has gathered attention, and resin molded products having provided on the surface thereof a beautiful wood-finish design (so-called “true wood-like processing”) by using native wood sliced veneers (hereinafter, also simply referred to as “sliced veneer”) are used for interior parts of automobiles, furniture, and home appliances, etc.

True wood-like processing of the resin molded products has been conventionally performed through steps as described next. First, a sliced veneer is, using an adhesive, pasted on the surface of a resin molded product that is molded in a certain shape. Next, a lower coating and an intermediate coating of a transparent resin or the like are sequentially provided on the surface of the pasted sliced veneer, and its surface is grinded/buffed. Then, a top coating is provided thereon, and grinding/buffing is performed to finish the surface in a mirror surface-like manner.

As described above, in conventional true wood-like processing, since the coating and grinding have to be performed repeatedly, time and effort are required, resulting in a problem of high manufacturing cost.

Therefore, as a technology that can solve the manufacturing-cost problem associated with the trouble of coating and grinding, Patent Literature 1 discloses a three-dimensionally moldable native wood sliced veneer including a sliced veneer, a transparent thermoplastic film for filling, which fills and impregnates conducting vessels and woody parts of the sliced veneer and which is melted and adhered to both obverse and reverse surfaces of the sliced veneer, and a transparent extensible film that has a rate of elongation of not lower than 400% and is thermocompression bonded to both surfaces of the thermoplastic film for filling. Thus, Patent Literature 1 discloses a “sliced veneer sheet” obtained by integrating a sliced veneer and a resin film. By placing such a sliced veneer sheet in an injection mold having a predetermined shape, and injection molding a base resin material; a resin molded product having true wood-like processing provided on the surface thereof can be easily and efficiently manufactured.

In Patent Literature 1, as a resin for forming the extensible film or thermoplastic film for filling; polyamide based, polyurethane based, polyester based, and EVA based thermoplastic resins are disclosed. However, since these resins have relatively high moisture permeability and oxygen permeability, there is a concern where, when the resins are used for interior decoration of automobiles where the resins are exposed for a long period of time particularly in an environment in which humidity and temperature greatly change, the sliced veneer that decorates the surface of the resin molded product may easily degrade or fade in color. Furthermore, EVA based thermoplastic resins have low heat resistance and are unsuitable to be used for interior decoration of automobiles.

As disclosed in Patent Literature 2, the problem of degradation or color-fading can be solved by using, as a resin film that is to be thermocompression bonded on the sliced veneer, a polyolefin resin having extremely low moisture permeability and oxygen permeability among various thermoplastic resins. Furthermore, the polyolefin resin is heat-resistant to temperatures equal to or higher than 100° C. which is necessary for application in interior decoration of automobiles.

### CITATION LIST

### Patent Literature

[PTL 1] Japanese Patent No. 3930491

[PTL 2] Japanese Laid-Open Patent Publication No. 2011-255542

### SUMMARY OF THE INVENTION

### Problems to be Solved by the Invention

However, although the polyolefin resin is a chemically stable plastic having low polarity and mostly consisting of carbon and hydrogen, and has extremely low moisture permeability and oxygen permeability when compared to other resins as described above; adhering the polyolefin resin to other materials or other plastics is extremely difficult because of having inferior surface wettability, and is generally considered impossible.

Thus, there is a problem where a highly durable sliced veneer sheet in which the sliced veneer and a resin film are firmly adhered to each other cannot be manufactured by simply thermocompression bonding the sliced veneer and the polyolefin resin film as disclosed in Patent Literature 2.

Thus, a main objective of the present invention is to provide a resin film that can be firmly adhered to a native wood sliced veneer, has extremely low moisture permeability and oxygen permeability, and can provide the sliced veneer with excellent automobile interior suitability. Another objective of the present invention is to provide a sliced veneer sheet obtained by using the resin film and is particularly suitable for use in interior decoration of automobiles, and an automobile interior member.

### Solution to the Problems

A first invention of the present invention is

a resin film 10 that is to be attached to a surface of a native wood sliced veneer 18, the resin film 10 including:

a melt-adhesion filling layer 12 formed of an olefin based resin whose melt flow rate (MFR: test condition being 170° C. and 2.1 kgf) is 2.5 to 33.0 g/10 min, the olefin based resin including a modified polyolefin resin; and

a functional layer 14 that is formed of a thermoplastic resin and that is to be laminated on a surface of the melt-adhesion filling layer 12.

In this invention, since the melt-adhesion filling layer 12 of the resin film 10 is formed of an olefin based resin that has a melt flow rate (MFR: test condition being 170° C. and 2.1 kgf) of 2.5 to 33.0 g/10 min, and includes a modified polyolefin resin; when the resin film 10 and the sliced veneer 18 are thermocompression bonded, the melt-adhesion filling layer 12 penetrates into deep parts of the sliced veneer 18 formed from conducting vessels and woody parts, and thereby the resin film 10 and the sliced veneer 18 become firmly adhered to each other mainly through an anchoring effect.

Here, the melt flow rate of the olefin based resin forming the melt-adhesion filling layer 12 is preferably within a range of 2.5 to 33.0 g/10 min, as described above. When the melt flow rate is lower than 2.5 g/10 min, impregnating ability and adhesiveness of the melt-adhesion filling layer 12 with respect to the sliced veneer 18 become inferior, whereas when the melt flow rate is higher than 33.0 g/10 min, film-formability deteriorates, in particular, film-formability during inflation molding deteriorates significantly.

In the invention described above, preferably, an intermediate layer 16 formed of an olefin based polymer alloy or polymer blend is additionally interposed between the melt-adhesion filling layer 12 and the functional layer 14. By interposing the intermediate layer 16 in such a manner, the melt-adhesion filling layer 12 and the functional layer 14 can be firmly joined even when the functional layer 14 is formed from a resin other than the olefin based resin as described later.

Furthermore, in the present invention, the thermoplastic resin forming the functional layer 14 is preferably at least one type of resin selected from the group consisting of polymethyl methacrylate resins (PMMA), polycarbonate resins (PC), polypropylene resins (PP), ABS resins (ABS), polyester based resins, polyethylene resins (PE), polystyrene resins (PS), and polyurethane resins (PU). With this, the functional layer 14 can be given the function of each of the resins described above.

Furthermore, in the present invention, blended in at least either one of the melt-adhesion filling layer 12 or the intermediate layer 16 is preferably a colored material that absorbs or diffuses electromagnetic waves having a wavelength of 380 to 700 nm, and more preferably ultraviolet rays having a wavelength of 380 to 400 nm and visible-light rays having a wavelength of 400 to 500 nm, which is close to the ultraviolet rays.

Ordinarily, a light-proof prescription of a general plastic having an ultraviolet ray absorbing agent blended therein absorbs or diffuses ultraviolet rays having a wavelength of not larger than 380 nm. However, by “blending in a colored material that absorbs or diffuses electromagnetic waves having a wavelength of 380 to 700 nm” to be used in combination with a conventional light-proof prescription, it becomes possible to absorb or diffuse ultraviolet rays having a wider wavelength range and visible-light rays close to those, and discoloration and degradation of the sliced veneer 18 adhered to the resin film 10 can be prevented more effectively. In addition, since “a colored material that absorbs or diffuses electromagnetic waves having a wavelength of 380 to 700 nm” is blended in at least either one of the melt-adhesion filling layer 12 or the intermediate layer 16, the functional layer 14, which is located at the outermost surface side when the resin film 10 is pasted to the sliced veneer 18, remains transparent and retains excellent glossiness. Thus, by simply pasting the resin film 10 on the surface of the sliced veneer 18, a light resistance coloring can be provided to the sliced veneer 18, and the surface of the sliced veneer 18 can be finished in a mirror surface-like manner.

Examples of “a colored material that absorbs or diffuses electromagnetic waves having a wavelength of 380 to 700 nm” include dyes and pigments having a brownish or blackish color including reddish brown, maroon, and dark red, etc., inorganic ultraviolet absorbing agents, and iron oxide based ultraviolet absorbers, etc.

A second invention of the present invention is a sliced veneer sheet 20, for interior decoration of automobiles, obtained by thermocompression bonding a thermoplastic resin film on both obverse and reverse surfaces of the native wood sliced veneer 18. Here, the resin film 10 according to any one of claims 1 to 4 is thermocompression bonded, at a temperature not lower than a melting point of the melt-adhesion filling layer 12 thereof, on at least an obverse surface side of the native wood sliced veneer 18.

In the present invention (second invention), preferably, a nonwoven fabric 34, whose main body is a fiber capable of maintaining its shape at a temperature higher than a melting point of a resin film 11 that is thermocompression bonded to a side of the reverse surface of the native wood sliced veneer 18, is interposed between the reverse surface of the native wood sliced veneer 18 and the resin film 11, or laminated on an outer surface side of the resin film 11.

Furthermore, a third invention of the present invention is an automobile interior member 32 obtained through injection molding, using the sliced veneer sheet 20 of the second invention.

### Advantageous Effects of the Invention

According to the present invention, it is possible to provide a resin film that can be firmly adhered to a native wood sliced veneer, has extremely low moisture permeability and oxygen permeability, and can give the sliced veneer excellent automobile interior suitability. In addition, by using the resin film of the present invention, it is possible to provide a sliced veneer sheet that is particularly suitable for use in interior decoration of automobiles and an automobile interior member.

### BRIEF DESCRIPTION OF THE DRAWINGS

FIG. 1 is a schematic diagram showing structures of a resin film according to one embodiment of the present invention, wherein (a) shows a resin film having a two-layer structure lacking an intermediate layer, and (b) shows a resin film having a three-layer structure with an intermediate layer.

FIG. 2 is an illustrative diagram showing one example of steps for manufacturing a sliced veneer sheet by using the resin film of the present invention.

FIG. 3 is an SEM picture (photograph as substitute for drawing) enlarging an end surface of a sliced veneer sheet according to a first embodiment of the present invention.

FIG. 4 shows a sliced veneer sheet according to a second embodiment of the present invention, wherein (a) is an illustrative diagram showing one example of steps for manufacturing the sliced veneer sheet, and (b) is an SEM picture (photograph as substitute for drawing) enlarging the end surface of the sliced veneer sheet obtained through the steps.

FIG. 5 shows a sliced veneer sheet according to a third embodiment of the present invention, wherein (a) is an illustrative diagram showing one example of steps for manufacturing the sliced veneer sheet, and (b) is an SEM picture (photograph as substitute for drawing) enlarging an end surface of the sliced veneer sheet obtained through the steps.

FIG. 6 is an illustrative diagram showing one example of steps for manufacturing an automobile interior member using the sliced veneer sheet of the present invention.

FIG. 7 is a photograph as substitute for drawing, showing a resin molded sample created for evaluating followability to a mold when injection molding using the sliced veneer sheet, wherein (a) shows its whole surface, and (b) shows the state of the surface in a partially enlarged manner.

### DESCRIPTION OF EMBODIMENTS

In the following, a resin film of the present invention, a sliced veneer sheet using the resin film, and an automobile interior member will be described with reference to the drawings.

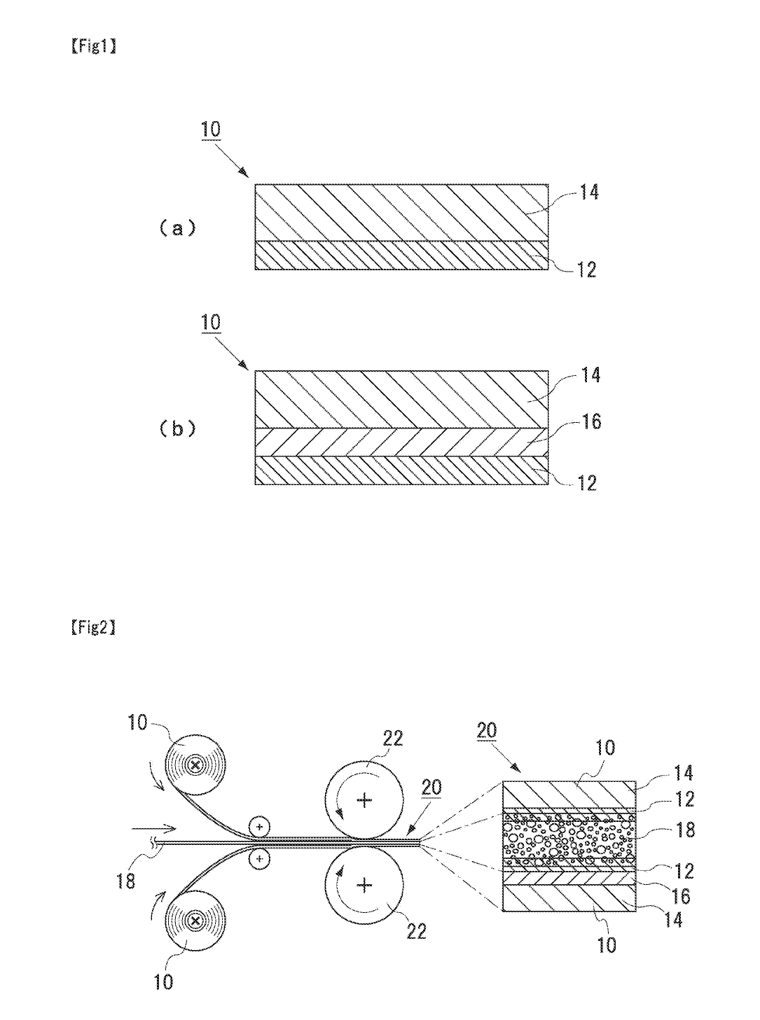

A resin film 10 of the present invention is attached to the surface of a native wood sliced veneer 18 (cf. FIG. 2), provides protection and decoration to the sliced veneer 18, and may include a melt-adhesion filling layer 12 and a functional layer 14 as shown in FIG. 1 (a), or may have a structure in which an intermediate layer 16 is interposed between the melt-adhesion filling layer 12 and the functional layer 14 as shown in FIG. 1 (b).

The thickness of the resin film 10 is not particularly limited, but is preferably in a range of 30 to 500 μm. When the thickness of the resin film 10 is smaller than 30 μm, maintaining sufficient strength required as a material for protecting and decorating the surface of the sliced veneer 18 becomes difficult, whereas when the thickness of the resin film 10 is larger than 500 μm, the resin film 10 becomes too rigid and flexibility (curved surface followability) required as a material for protecting and decorating the surface of the sliced veneer 18 is compromised.

The melt-adhesion filling layer 12 is a layer that is thermally melted to penetrate into the sliced veneer 18 and fill conducting vessels and woody parts of the sliced veneer 18 when the resin film 10 is attached on the surface of the native wood sliced veneer 18. The melt-adhesion filling layer 12 is formed of an olefin based resin whose melt flow rate (MFR: test condition being 170° C. and 2.1 kgf) measured conforming to JIS K6922-2 is 2.5 to 33.0 g/10 min, preferably 3.0 to 10.0 g/10 min, and more preferably 4.0 to 7.0 g/10 min. As described above, when the MFR is lower than 2.5 g/10 min, impregnating ability and adhesiveness of the melt-adhesion filling layer 12 with respect to the sliced veneer 18 become inferior, whereas when the MFR is higher than 33.0 g/10 min, film-formability deteriorates, in particular, film-formability during inflation molding deteriorates significantly.

As described above, the polyolefin resin is a chemically stable plastic having low polarity, and thereby even if the MFR is raised to increase fluidity when the polyolefin resin is thermally melted, wettability of the surface is inferior and adhesion to the sliced veneer 18 or other resins is extremely difficult. Thus, in the resin film 10 of the present invention, for the purpose of improving adhesiveness with respect to the sliced veneer 18 or other resins, a modified polyolefin resin is blended in the olefin based resin forming the melt-adhesion filling layer 12. The obtained modified polyolefin resin is obtained through modification (e.g., graft modification) of the olefin based resin or a copolymer of the olefin based resin and another resin, using alpha, beta-unsaturated carboxylic acid or a derivative thereof (e.g., acrylic acid, methyl acrylate), or alicyclic carboxylic acid or a derivative thereof (e.g., maleic anhydride).

The modified polyolefin resin introduces a polar group into the non-polar polyolefin resin to provide adhesiveness with different materials such as the sliced veneer 18 and other resins. The blending ratio of the modified polyolefin resin in the whole olefin based resin forming the melt-adhesion filling layer 12 is preferably in a range of 2 wt % to 80 wt %, and more preferably in a range of 5 wt % to 20 wt %. When the blending ratio of the acid modified polyolefin resin in the whole olefin based resin forming the melt-adhesion filling layer 12 is less than 2 wt %, affinity and impregnating ability with respect to the sliced veneer deteriorate; whereas when the blending ratio is more than 80 wt %, although impregnating ability becomes extremely good, the amount of resin remaining on the surface of the sliced veneer becomes less, and strength for adhering to the functional layer 14 (or the intermediate layer 16) may become lower.

The functional layer 14 is an outermost layer arranged on the obverse side (or an outermost layer arranged on the reverse side) when forming a sliced veneer sheet 20 by attaching the resin film 10 to the sliced veneer 18. The functional layer 14 is a layer for exerting the functions and properties specific to the resin that forms the layer. Thus, when the sliced veneer sheet 20 manufactured using the resin film 10 of the present invention is to be used for interior decoration of automobiles, the functional layer 14 is preferably formed from at least one type of resin selected from the group consisting of polymethyl methacrylate resins (PMMA), polycarbonate resins (PC), polypropylene resins (PP), ABS resins (ABS), polyethylene terephthalate resins (PET), polyester based resins such as an ester elastomer whose hard segment is polybutylene terephthalate, polyethylene resins (PE), polystyrene resins (PS), and polyurethane resins (PU). For example, surface texture becomes fine when the functional layer 14 is formed of a polyurethane resin, or shock resistance improves when the functional layer 14 is formed of an ABS resin. In such manner, functions specific to each of the resins described above can be given to the surface of the resin film 10 (and ultimately to the surface of the sliced veneer sheet 20) via the functional layer 14.

As described later, upon manufacturing an automobile interior member 32 by joining a base resin material 30 and the sliced veneer sheet 20 manufactured using the resin film 10 of the present invention (cf. FIG. 6); the sliced veneer sheet 20 and the base resin material 30 can be firmly joined and integrated with high inter-layer strength by forming the resin forming the functional layer 14 and the base resin material 30 that is to be joined with the functional layer 14 from the same or same type of resin.

As shown in FIG. 1 (b), the intermediate layer 16 is a layer interposed between the melt-adhesion filling layer 12 and the functional layer 14 if necessary. As described above, the olefin based resin is a chemically stable plastic having low polarity, and thereby even if the modified polyolefin resin is blended in the melt-adhesion filling layer 12, sufficient inter-layer strength between the melt-adhesion filling layer 12 and the functional layer 14 cannot be obtained in some cases depending on the type of resin forming the functional layer 14. In such a case, the intermediate layer 16 formed of an olefin based polymer alloy or polymer blend is preferably interposed between the melt-adhesion filling layer 12 and the functional layer 14.

Here, the material resin that is to be blended with the olefin based resin to obtain the olefin based polymer alloy or polymer blend is preferably the same or the same type of resin forming the functional layer 14. By doing so, the melt-adhesion filling layer 12 and the functional layer 14 can be joined firmly with high inter-layer strength via the intermediate layer 16.

When manufacturing the resin film 10 formed from the layers 12, 14, and 16; a film manufacturing method known in the art such as inflation method, T-die method, or tubular method may be used. For the purpose of improving production efficiency, reducing the burden of inventory management, and improving handleability of a product; the layers 12, 14, and 16 are preferably formed and laminated/integrated simultaneously. However, the layers 12, 14, and 16 may be manufactured separately, and laminated and thermocompression bonded in a predetermined order when being attached to the surface of the sliced veneer 18.

To the layers 12, 14, and 16 forming the resin film 10, besides the material resin, additives such as antiblocking agents, lubricants, ultraviolet ray absorbing agents, weathering stabilizers, flame retardants, and colored materials that absorb or diffuse electromagnetic waves having a wavelength of 380 to 700 nm may be added if necessary.

When adding, to the resin film 10, a colored material that absorbs or diffuses electromagnetic waves having a wavelength of 380 to 700 nm, i.e., ultraviolet rays having a wavelength of 380 to 400 nm and visible-light ray having a wavelength of 400 to 700 nm, more specifically dyes and pigments having a brownish or blackish color also including reddish brown, maroon, and dark red, etc., inorganic ultraviolet absorbing agents, and iron oxide based ultraviolet absorbers, etc.; the adding is preferably conducted to at least either one of the melt-adhesion filling layer 12 or the intermediate layer 16. By blending in such chemical agents that are colored in at least either one of the melt-adhesion filling layer 12 or the intermediate layer 16; the functional layer 14 remains transparent and retains excellent glossiness. As a result, by simply thermocompression bonding the resin film 10 formed as described above on the surface of the sliced veneer 18, a light resistance coloring can be provided to the sliced veneer 18, and the surface of the sliced veneer 18 can be finished in a mirror surface-like manner.

Next, with reference to FIG. 2, the method for manufacturing “the sliced veneer sheet 20” using the resin film 10 formed as described above will be described.

The sliced veneer sheet 20 of the present invention is obtained by attaching the resin film on both surfaces (both obverse and reverse surfaces) of the native wood sliced veneer 18, wherein the resin film 10 is attached at least on the obverse surface side of the native wood sliced veneer 18 for protecting and decorating the surface of the sliced veneer 18. When the resin film 10 of the present invention is attached on both obverse and reverse surfaces of the native wood sliced veneer 18, additional advantageous effect of being able to suppress warping of the sliced veneer sheet 20 etc., can be obtained.

The native wood sliced veneer 18 is a thin plate material having a thickness of about 0.1 to 2.0 mm, obtained through slice processing or rotary processing of a laminate lumber obtained by laminating natural raw wood or veneer of raw wood. Representative raw wood manufactured into the sliced veneer 18 include Japanese cypress, hiba cypress. Japanese zelkova, Japanese oak, Japanese ash, paulownia, Japanese cedar, mahogany, walnut, oak, teak, rosewood, Japanese horse chestnut, red sandalwood, ebony, elm tree, bamboo, and maple, etc.

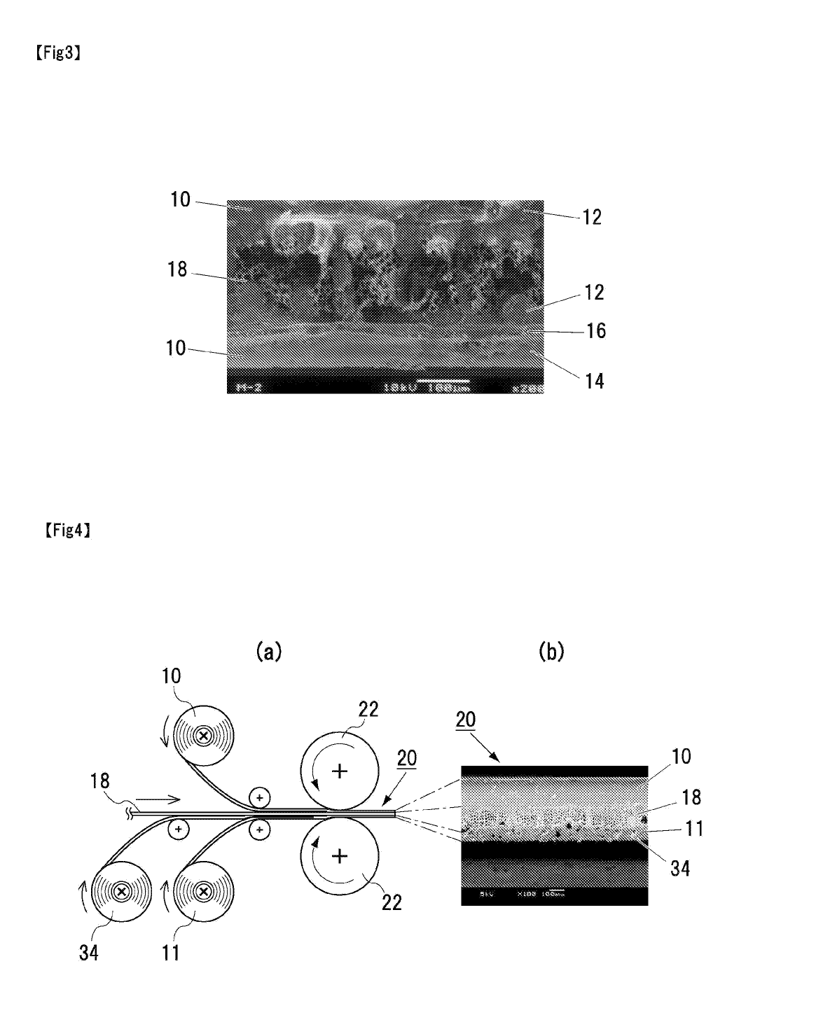

When manufacturing the sliced veneer sheet 20 by laminating and integrating the sliced veneer 18 and the resin film 10 described above, heating rolls 22 as shown in FIG. 2 are used. More specifically, the resin film 10 is laminated on at least one surface of the sliced veneer 18, the resulting laminate sheet is sent between a top and bottom pair of the heating rolls 22 that have been heated to or beyond the melting point of the resin forming the melt-adhesion filling layer 12, thermocompression bonded while having a predetermined pressure applied thereto, and cooled. As a result, as shown in FIG. 3, the melt-adhesion filling layer 12 penetrates into the sliced veneer 18, and both are firmly adhered to obtain the sliced veneer sheet 20.

In FIG. 2, although the two-layer structured resin film 10 not having the intermediate layer 16 is laminated on an upper side of the sliced veneer 18, and the three-layer structured resin film 10 having the intermediate layer 16 is laminated on a lower side of the sliced veneer 18; the combination of the sliced veneer 18 and the resin film 10 is not limited thereto.

Furthermore, the method for manufacturing the sliced veneer sheet 20 is not limited only to the method of successively manufacturing the sliced veneer sheet 20 by using the top and bottom pair of the heating rolls 22 as described above; and may be a (batch type) method of laminating and thermocompression bonding the sliced veneer 18 and the resin film 10 cut in a predetermined length using a flat pressing machine.

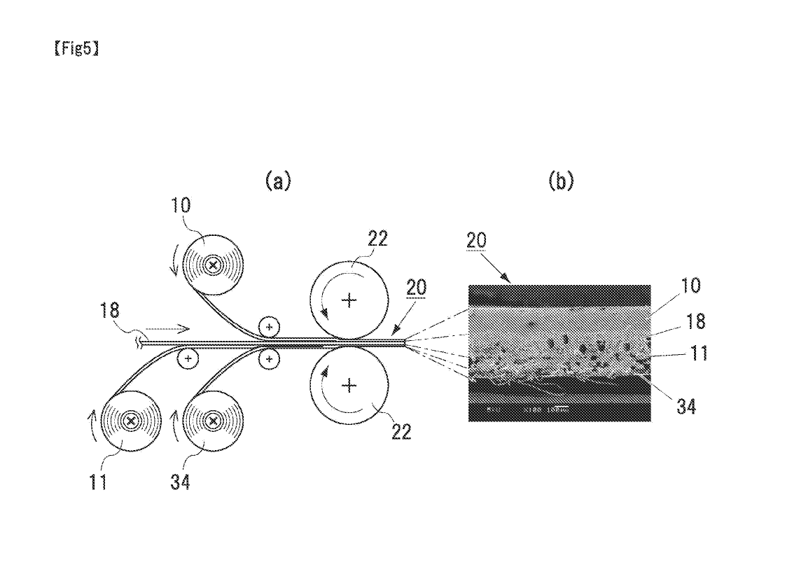

Furthermore, when manufacturing the sliced veneer sheet 20, it is suitable to add an improvement as described next if necessary. That is, as shown in FIG. 4 (a), in addition to laminating the resin film 10 on the surface of the sliced veneer 18, when laminating and thermocompression bonding using the heating rolls 22 a resin film 11 (needless to say that the resin film 11 may be the resin film 10 of present invention) for the reverse surface side on the reverse surface of the sliced veneer 18; a nonwoven fabric 34, whose main body is a fiber capable of maintaining its shape at a temperature higher than a melting point of the resin film 11 that is thermocompression bonded to the side of the reverse surface of the sliced veneer 18, is interposed between the reverse surface of the sliced veneer 18 and the resin film 11. Then, as shown in FIG. 4 (b), the nonwoven fabric 34 is arranged so as to span from the whole inside to the outer surface of the resin film 11 for the reverse surface side, and the resin film 11 is structured like FRP (Fiber Reinforced Plastics). As a result, as described later, when manufacturing the automobile interior member 32 using injection molding, an adhesion layer formed on the outer surface side of the resin film 11 (to adhere to the base resin material 30) is prevented from melting and flowing out due to heat, pressure, or flow of the base resin material 30 in a heated/molten state, and poor adhesion therebetween can be prevented. In addition, an anchoring effect is created between the base resin material 30 and the nonwoven fabric 34 dispersed on the outer surface of the resin film 11, and the two can be joined firmly. Furthermore, as described above, since the resin film 11 is structured like FRP, the resin film 11 can also provide rigidity to the sliced veneer sheet 20.

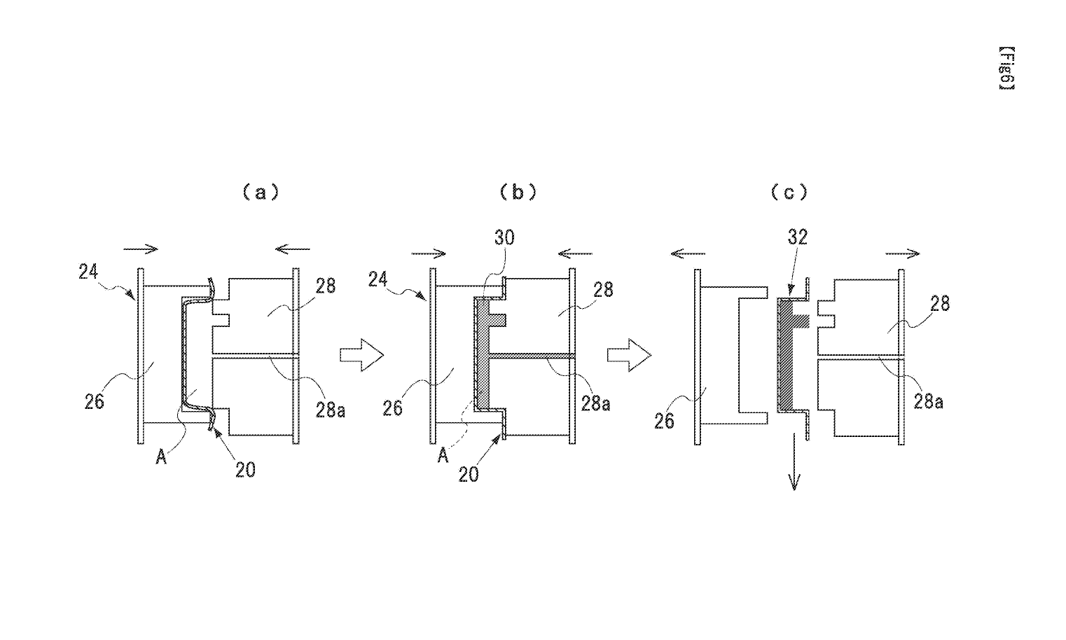

Furthermore, as shown in FIG. 5 (a), in addition to laminating the resin film 10 on the surface of the sliced veneer 18, when laminating and thermocompression bonding using the heating rolls 22 the resin film 11 (needless to say that the resin film 11 may also be the resin film 10 of the present invention) for the reverse surface side on the reverse surface of the sliced veneer 18; the nonwoven fabric 34, whose main body is a fiber capable of maintaining its shape at a temperature higher than a melting point of the resin film 11, is laminated on the outer surface side of the resin film 11. Then, as shown in FIG. 5 (b), the nonwoven fabric 34 is arranged so as to span from inside the outer surface side to the outer surface of the resin film 11. As a result, similar to the case described above, when manufacturing the automobile interior member 32 using injection molding, an adhesion layer formed on the outer surface side of the resin film 11 (to adhere to the base resin material 30) is prevented from melting and flowing out due to heat, pressure, or flow of the base resin material 30 in a heated/molten state, and poor adhesion therebetween can be prevented. In addition, since the nonwoven fabric 34 is arranged more toward the outer surface of the resin film 11 than the case described above, a stronger anchoring effect is obtained between the nonwoven fabric 34 and the base resin material 30, and the two can be joined more firmly. It should be noted that although rigidity of the sliced veneer sheet 20 cannot be expected to increase when the nonwoven fabric 34 is laminated on the outer surface side of the resin film 11, flexibility of the sliced veneer sheet 20 is not compromised.

In the examples shown in FIG. 4 (b) and FIG. 5 (b), bird's-eye maple having a thickness of 200 μm is prepared as the sliced veneer 20, and the resin film 10 having a thickness of 150 μm is prepared. Furthermore, the resin film 11 is a three-layer structured resin film having a thickness of 100 μm and including the sliced veneer adhesion layer, the intermediate layer, and the functional layer, wherein each of the prepared layers contains an ester elastomer whose hard segment is polybutylene terephthalate. Further, as the nonwoven fabric 34, a spun lace nonwoven fabric (stock number 7840A, manufactured by Shinwa Corp.) formed from PET fiber whose weight per area is 40 g/m² is prepared. Those described above are laminated in the order shown in FIG. 4 (a) or FIG. 5 (a), and thermocompression bonded using heating rolls at 170° C. to obtain the sliced veneer sheet 20.

In the description above, although the nonwoven fabric 34 is limited to one “whose main body is a fiber capable of maintaining its shape at a temperature higher than a melting point of the resin film 11”; “a fiber capable of maintaining its shape at a temperature higher than a melting point of the resin film 11” is not simply limited to a thermoplastic fiber whose melting point is higher than that of the resin film 11, and is a concept also including, for example, cotton linters and regenerated cellulose fibers such as rayon and Lyocell. Furthermore, as the method for manufacturing the nonwoven fabric 34, both a dry method and a wet method can also be used.

Next, with reference to FIG. 6, by using the sliced veneer sheet 20 in FIG. 3 obtained by thermocompression bonding the resin film 10 of the present application on both obverse and reverse surfaces of the sliced veneer 16 of the present invention, the method for manufacturing “the automobile interior member 32” will be described.

First, as shown in FIG. 6 (a), the sliced veneer sheet 20 having the resin film 10 thermocompression bonded to both surfaces thereof is mounted in a first mold 26 (female mold) of an injection molding device 24. The sliced veneer sheet 20 may be formed in advance in a predetermined shape conforming to the inner surface of the first mold 26 by vacuum-forming etc.

Next, as shown in FIG. 6 (b), the base resin material 30, which has been heated and melted, is extruded into a cavity ‘A’ through a gate 28a disposed on a second mold 28, from a nozzle of an injection unit that is not shown, and the first mold 26 and the second mold 28 are closed.

Then, the automobile interior member 32 is completed by cooling and hardening: a surface protection-and-decoration portion formed by the sliced veneer sheet 20; and a main body portion formed by the base resin material 30. Next, as shown in FIG. 6 (c), the completed automobile interior member 32 is released from the cavity A.

In this method for manufacturing the automobile interior member 32, the functional layer 14 of the resin film 10 located on the surface side that makes contact with the base resin material 30 of the sliced veneer sheet 20, and the base resin material 30 that is to be joined with the functional layer 14 are preferably formed from the same or the same type of material. By doing so, the sliced veneer sheet 20 and the base resin material 30 can be firmly joined and integrated with high inter-layer strength.

Furthermore, when the surface of the first mold 26 is finished in a mirror surface-like manner, the effort of separately providing mirror-surface processing on the automobile interior member 32 can be omitted since the mirror surface is transferred to the surface of the completed automobile interior member 32.

### EXAMPLES

In the following, although the resin film of the present invention will be described specifically using Examples and Comparative Examples, the present invention is not limited to those Examples.

Property evaluation of each resin film (more specifically, melt-adhesion filling layer film) in the Examples and Comparative Examples was conducted by the following methods.

1. Property Evaluation of Resin Film

(1) Evaluation of Manufacturing Property of Melt-Adhesion Filling Layer Film

(a) MFR of resin forming melt-adhesion filling layer: Measured conforming to JIS K6922-2 under a test condition of 170° C. and 2.1 kgf.

(b) T-die processability: A resin material mixture of a composition forming the melt-adhesion filling layer was, using a mono-axial extrusion machine whose screw diameter was 35 mm, introduced in a T-die whose width was 400 mm and designed such that a flow of a melt resin within a die is homogeneous, and extruded such that the resin temperature at a die outlet was 170° C. A lip gap was set to 1.0 mm. The melt resin film extruded out from the die was cooled to 30° C. using a cooling roll to obtain an olefin based film whose layer thickness was 50 μm, visually observed regarding T-die processability, and evaluated using a four-grade scale of EXCELLENT. GOOD. AVERAGE, and BAD.

(c) Inflation Processability: When forming a monolayer film, a resin composition of a composition forming a melt-adhesion filling layer was, using a 35-mm extruder, melted and knead at an extrusion temperature of 200° C. and a discharge amount of 5 kg/hr, extruded into a cylindrical shape using a circular lip having a lip clearance of 0.5 mm and a peripheral length of 157 mm (diameter 50 mm), and cooled by blowing air thereto to produce an inflation film having a thickness of 50 μm. When forming a multilayer film, a resin composition of a composition forming a melt-adhesion filling layer was used as an internal layer, a polypropylene resin (random polypropylene: WINTEC WFX4TA manufactured by Japan Polychem Corp.) was used as an intermediate layer and an outer layer, and a three-layered co-extrusion inflation film was produced using a die temperature of 190° C. Bore diameter of the extruder was internal layer/intermediate layer/outer layer=45/45/45 (unit: mm in diameter); layer composition ratio was internal layer/intermediate layer/outer layer=1/1/1 (total thickness=150 μm); and a laminated body molding speed was set to 8 m/min. Inflation processability at each inflation film molding process was visually observed, and evaluated using a four-grade scale of EXCELLENT, GOOD, AVERAGE, and BAD.

(2) Physical Property Evaluation of Melt-Adhesion Filling Layer Film

(a) Impregnating Ability: A film, which has a thickness of 0.05 mm and which becomes a melt-adhesion filling layer, of an Example or a Comparative Example was set on both upper and lower surfaces of a native wood sliced veneer (bird's-eye maple) having a thickness of 0.20 mm. In addition, polypropylene films (functional layers) each having a thickness of 0.10 mm were layered on outer sides thereof. Next, thermocompression bonding was performed thereon using a hot press at 180° C. and 1 MPa for 30 seconds. Then, the product was cooled to ordinary temperature while still being compressed to obtain a sliced veneer sheet.

A sample having a dimension of width 30 mm×length 100 mm was cut out from substantially the central portion of the obtained sliced veneer sheet, and an SEM picture enlarging the end surface of the sample by 200-fold was captured. The degree of penetration of the melt-adhesion filling layer into the sliced veneer was visually observed, and evaluated using a four-grade scale of EXCELLENT. GOOD. AVERAGE, and BAD.

(b) Adhesiveness: A sample created with the same method as for the impregnating ability evaluation was used. The polypropylene films on both obverse and reverse surfaces were set on clamps of a tensile strength tester, and were pulled to measure peeling strength between the sliced veneer and the polypropylene films. The obtained result was evaluated using a four-grade scale of EXCELLENT, GOOD, AVERAGE, and BAD.

### Example 1

WINTEC (Registered trademark; stock number WFX4TA) manufactured by Japan Polypropylene Corp., was prepared as a highly transparent polypropylene resin; PP2100 manufactured by Nissen Chemitec Corp., was prepared as a high MFR polypropylene resin for molecular weight adjustment; and YOUMEX (Registered trademark; stock number 1010) manufactured by Sanyo Chemical Industries, Ltd., was prepared as a maleic acid modified polypropylene resin. Then, 49 wt % of the highly transparent polypropylene resin, 41 wt % of the high MFR polypropylene resin for molecular weight adjustment, and 10 wt % of the maleic acid modified polypropylene resin were mixed. Furthermore, with respect to 100 parts by weight of the resin mixture, 0.5 parts by weight of an ultraviolet ray absorbing agent ADKSTAB (Registered trademark; stock number 1413) manufactured by ADEKA Corp., and 0.5 parts by weight of an antioxidant IRGANOX (Registered trademark; stock number 1010) manufactured by BASF (former Ciba Japan K.K.) were added thereto. The mixture was extruded in a strand-like manner at a temperature of 170° C. using a 35-mm diameter extruder that had vent and an 80-mesh wire net mounted thereto. The strand was water-cooled and cut to prepare a compound for the melt-adhesion filling layer. The obtained compound was dried for 8 hours at 90° C., and one part thereof was used for evaluating the manufacturing property of the melt-adhesion filling layer film.

Next, the compound was dropped in a 35-mm diameter air-cooled inflation film forming machine whose film-forming temperature was set at 200° C. to form a melt-adhesion filling layer film having a thickness of 50 μm.

The result of evaluating the physical property of the obtained film, and the result of evaluating the film manufacturing property using the formulation described above are shown in Table 1.

### Example 2

Evaluation of the manufacturing property of a melt-adhesion filling layer film and film physical property of the obtained film was conducted in a manner similar to Example 1, except that: MODIC (Registered trademark; stock number F534A) manufactured by Mitsubishi Chemical Corp., was prepared as a modified polyolefin based resin; PP2100 manufactured by Nissen Chemitec Corp., was prepared as a high MFR polypropylene resin for molecular weight adjustment; a compound for the melt-adhesion filling layer was prepared by mixing 80 wt % of the modified polyolefin based resin and 20 wt %/o of the high MFR polypropylene resin for molecular weight adjustment. The obtained results are shown in Table 1.

### Comparative Example 1

Evaluation of the manufacturing property of a melt-adhesion filling layer film and film physical property of the obtained film was conducted in a manner similar to Example 1, except that the compound for the melt-adhesion filling layer was prepared only from WINTEC (Registered trademark; stock number WFX4TA), which is a highly transparent polypropylene resin, manufactured by Japan Polypropylene Corp. The obtained results are shown in Table 1.

### Comparative Example 2

Evaluation of the manufacturing property of a melt-adhesion filling layer film and film physical property of the obtained film was conducted in a manner similar to Example 1, except that the compound for the melt-adhesion filling layer was prepared only from PP2100, which is a high MFR polypropylene resin for molecular weight adjustment, manufactured by Nissen Chemitec Corp. The obtained results are shown in Table 1.

### Comparative Example 3

Evaluation of the manufacturing property of a melt-adhesion filling layer film and film physical property of the obtained film was conducted in a manner similar to Example 1, except that: PP2100 manufactured by Nissen Chemitec Corp., was prepared as a high MFR polypropylene resin for molecular weight adjustment; YOUMEX (Registered trademark; stock number 1010) manufactured by Sanyo Chemical Industries, Ltd., was prepared as a maleic acid modified polypropylene resin; and the compound for the melt-adhesion filling layer was prepared by mixing 80 wt % of the high MFR polypropylene resin for molecular weight adjustment and 20 wt % of the maleic acid modified polypropylene resin. The obtained results are shown in Table 1.

TABLE 1

| | MFR | T-die | Inflation | Impreg- | |
|---|---|---|---|---|---|
| | (g/10 | process- | process- | nating | Adhesive- |
| Sample | min.) | ability | ability | ability | ness |
| Example 1 | 7.7 | GOOD | GOOD | EXCEL- | EXCEL- |
| | | | | LENT | LENT |
| Example 2 | 8.3 | GOOD | GOOD | EXCEL- | EXCEL- |
| | | | | LENT | LENT |
| Comparative | 2.0 | EXCEL- | EXCEL- | BAD | BAD |
| Example 1 | | LENT | LENT | | |
| Comparative | 33.4 | AVER- | BAD | AVER- | BAD |
| Example 2 | | AGE | | AGE | |
| Comparative | 45.8 | BAD | BAD | EXCEL- | GOOD |
| Example 3 | | | | LENT | |

As shown in Table 1, the melt-adhesion filling layer films of the Examples can be seen to have both fine manufacturability and function as the melt-adhesion filling layer. On the other hand, in Comparative Example 1 in which the MFR of the resin forming the melt-adhesion filling layer is lower than the lower limit of the present invention, although manufacturability of the film was fine, the obtained film did not function as the melt-adhesion filling layer at all. Conversely, when the MFR of the resin forming the melt-adhesion filling layer largely exceeds the upper limit of the present invention, mainly, manufacturability of the film can be seen to deteriorate significantly.

2. Property Evaluation of Sliced Veneer Sheet

(1) Extension Rate of Sliced Veneer Sheet

On both obverse and reverse surfaces of a native wood sliced veneer (bird's-eye maple) having a thickness of 0.20 mm, polypropylene films each having a thickness of 0.05 mm were thermocompression bonded via the melt-adhesion filling layer films of Example 1 above to obtain a sliced veneer sheet having a thickness of 0.35 mm. Extension rates were measured by the following method for this sliced veneer sheet and a native wood sliced veneer (bird's-eye maple) having a thickness of 0.20 mm without having the resin films laminated thereto.

More specifically, a test sample having a dimension of width 10 mm×length 200 mm was cut out from each sheet, and an extension rate thereof was measured by conducting a tensile test under a condition of room temperature of 15±5° C., humidity of 30±5%, speed of 1 mm/min, and gage length of 100 mm, using Precision Universal Tester “Autograph” manufactured by Shimadzu Corp.

As a result, it became clear that, by laminating the native wood sliced veneer with the resin film formed from the melt-adhesion filling layer film and the polypropylene film, the extension rate increased by about 2-fold in the fiber direction of the native wood sliced veneer and by about 4- to 5-fold in a direction orthogonal to the fiber direction.

(2) Mold Followability when Using Sliced Veneer Sheet for Injection Molding

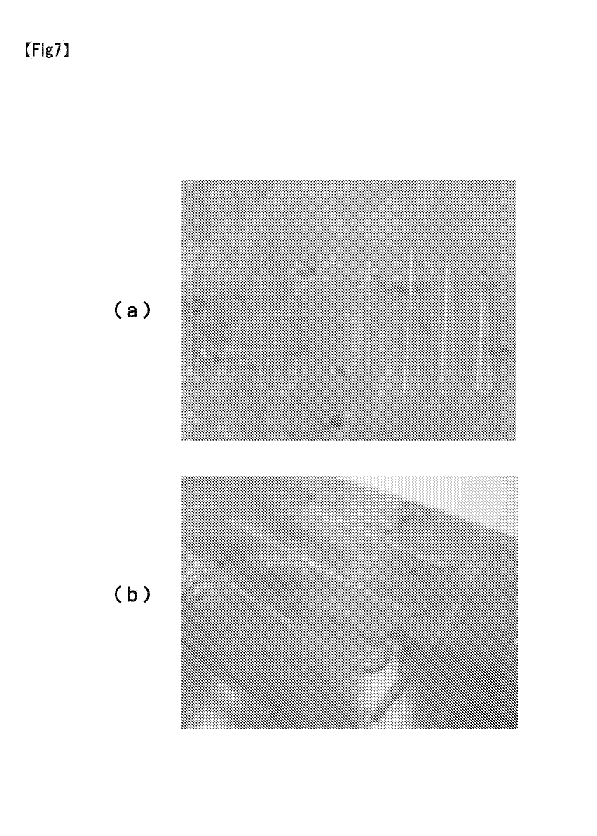

The same sliced veneer sheet used for measuring the extension rate was prepared, and this sliced veneer sheet was set in test metal-molds (several types with different curvature and depth of concave-convex parts were used) mounted to an injection molding machine NS-60-9A manufactured by Nissei Plastic Industrial Co., Ltd. Then, the polypropylene resin was injection molded on the reverse surface side of the sliced veneer sheet under a condition of injection resin temperature of 200° C. and injection pressure of 60 MPa to obtain a resin molded sample for evaluating followability to the mold as shown in FIG. 7. For comparison, a resin molded sample was also created by using, instead of the sliced veneer sheet, a native wood sliced veneer (bird's-eye maple) having a thickness of 0.20 mm but not having the resin film laminated thereon. Followability to the mold was evaluated by examining whether cracking of the sliced veneer exists at a flat surface of a convex portion and a stepped part of each resin molded sample.

As a result, the sliced veneer sheet having the resin films laminated thereon had an increased extension rate as described above. In addition, followability to the mold was significantly improved since anisotropy was lessened and the difference in extension rate between the fiber direction of the sliced veneer and the direction orthogonal thereto was almost eliminated. Thus, the sliced veneer sheet can handle shapes having a large curvature and deep concavities and convexities etc., which has not been possible conventionally (i.e., when a native wood sliced veneer was used alone).

### DESCRIPTION OF THE REFERENCE CHARACTERS

10 resin film
11 resin film (which is to be thermocompression bonded to a reverse surface side of a native wood sliced veneer)
12 melt-adhesion filling layer
14 functional layer
16 intermediate layer
18 native wood sliced veneer (sliced veneer)
20 sliced veneer sheet
22 heating roll
24 injection molding device
26 first mold (female mold)
28 second mold
30 base resin material
32 automobile interior member
34 nonwoven fabric

1. A resin film that is to be attached to a surface of a native wood sliced veneer, the resin film comprising:
a melt-adhesion filling layer formed of an olefin based resin whose melt flow rate (MFR: test condition being 170° C. and 2.1 kgf) is 2.5 to 33.0 g/10 min, the olefin based resin including a modified polyolefin resin; and
a functional layer that is formed of a thermoplastic resin and that is to be laminated on a surface of the melt-adhesion filling layer.

2. The resin film according to claim 1, wherein an intermediate layer formed of an olefin based polymer alloy or polymer blend is additionally interposed between the melt-adhesion filling layer and the functional layer.

3. The resin film according to claim 1, wherein the thermoplastic resin forming the functional layer is at least one type of resin selected from the group consisting of polymethyl methacrylate resins, polycarbonate resins, polypropylene resins, ABS resins, polyester based resins, polyethylene resins, polystyrene resins, and polyurethane resins.

4. The resin film according to claim 1, wherein a colored material that absorbs or diffuses electromagnetic waves having a wavelength of 380 to 700 nm is blended in at least either one of the melt-adhesion filling layer or the intermediate layer.

5. A sliced veneer sheet, for interior decoration of automobiles, obtained by thermocompression bonding a thermoplastic resin film on both obverse and reverse surfaces of a native wood sliced veneer, wherein
the resin film according to claim 1 is thermocompression bonded, at a temperature not lower than a melting point of the melt-adhesion filling layer thereof, on at least an obverse surface side of the native wood sliced veneer.

6. The sliced veneer sheet, for interior decoration of automobiles, according to claim 5, wherein
a nonwoven fabric, whose main body is a fiber capable of maintaining its shape at a temperature higher than a melting point of a resin film that is thermocompression bonded to a side of the reverse surface of the native wood sliced veneer, is interposed between the reverse surface of the native wood sliced veneer and the resin film.

7. The sliced veneer sheet, for interior decoration of automobiles, according to claim 5, wherein
a nonwoven fabric, whose main body is a fiber capable of maintaining its shape at a temperature higher than a melting point of a resin film that is thermocompression bonded to the reverse surface of the native wood sliced veneer, is laminated on an outer surface side of the resin film.

8. An automobile interior member obtained through injection molding using the sliced veneer sheet according to claim 5.
